(19) United States
(12) Patent Application Publication
(10) Pub. No.: US 2025/0113828 A1
(43) Pub. Date: Apr. 10, 2025

(54) METHOD OF USING/APPLYING A KERATIN HYDROLYSIS PEPTIDE SOLUTION TO IMPROVE THE FERTILIZER USAGE EFFICIENCY IN COTTON

(71) Applicant: CH Biotech R&D Co., Ltd., Nantou City (TW)

(72) Inventors: Jenn Wen HUANG, Taichung (TW); Yi-Chiao CHAN, Keelung (TW); Yu-Yi WU, Taichung (TW); Nai-Hua YE, Changhua (TW)

(73) Assignee: CH Biotech R&D Co., Ltd., Nantou City (TW)

(21) Appl. No.: 18/409,790

(22) Filed: Jan. 11, 2024

(30) Foreign Application Priority Data
Oct. 6, 2023 (TW) 112138605

(51) Int. Cl. A01N 63/50; A01P 21/00

(52) U.S. Cl. CPC A01N 63/50; A01P 21/00

(57) ABSTRACT

Present invention teaches the method of using a keratin hydrolysis peptide (“KHP”) solution to improve the efficacy of fertilizer usage and absorption by cotton plants. By selectively choosing specific weights of feathers and water, and treating the mixture to a high-temperature high-pressure hydrolysis process, the resulting solution is confirmed to contain at least 253 peptides and then infused to the fertilized soil in which the cotton seeds are planted and grown. Optionally, the KHP solution can be diluted by water, as disclosed in the specification, for applying to the fertilized soil around the cotton plants.

### PRIORITY CLAIM TO FOREIGN APPLICATION

Applicant hereby makes priority claim to a Taiwan application, number 112138605 having the Taiwan filing date of Oct. 6, 2023.

### BACKGROUND OF THE INVENTION

Present invention disclosed and claimed the method and application of a keratin hydrolysis peptide (“KHP”) solution for improving the fertilizer utilization and absorption by cotton plants, by using the thermally hydrolyzed feather keratin peptide solution to the soil when the cotton seeds are sowed.

With the application of the KHP solution as disclosed herein, the amount of fertilizer usage can be reduced while the efficiency of photo synthesis, the growth of root systems and above-ground biomass of cotton plants are improved.

The KHP solution is made by a hydrolysis process using feathers and water, with one version of the solution using feathers only, via a high-temperature and high-pressure process, resulting in a solution that has many beneficial applications in the fields of horticulture, agriculture and potentially other farming businesses.

Hydrolyzed keratin has long been used to strengthen hairs, reduce hair splitting and breakage. Other beneficial uses include skin moisturization and wound healing. Keratin hydrolysate has also been known to function as a biofertilizer, boosting plants' growth by enhancing the plants' ability to receive and utilize nutrients, including commonly applied fertilizers.

Cotton, belonging in the Malvaceae Family, is a perennial plant that favors warm weathers with lots of lights. Wet and damp environment, on the other hand, is not ideal for cotton's growth. When grown in deep and loose soil with proper nutrients supply, the reproductive growth and developmental growth will simultaneously happen, producing new stems/leaves and buds/flowers. However, to keep up with such reproductive and developmental growths, sufficient and proper management of fertilizers becomes very important.

Various studies have shown that, given the common NPK fertilization adopted by most farmers, only less than 30-50% of the fertilizers were actually absorbed by the cotton plants, with the majority being wasted, or, worse, causing long-term negative impact to the environment.

Guided by the new concept of Fertilizer Use Efficiency (FUE), as a new benchmark in assessing/evaluating how people should use fertilizers to increase agricultural production, the inventors of present application developed a KHP solution that can be mixed to a fertilizer, used sparingly, to improve the fertilizer intake and absorption by the cotton plants with healthier growth and development. By the application of the KHP solution as disclosed herein, the goal of reducing the fertilizer use without reducing the production yield is reached.

### SUMMARY OF THE INVENTION

The keratin solution is primarily based upon feather, which contains 85-91% keratin, 13-15% organic nitrogen, 1.6-2% organic sulfur, as well as other materials. The high keratin content has drawn many prior researches that work to break down, by enzyme, chemical agents, or fermentation process, into peptides, amino acids and other smaller molecules that can be used for animal feeds, plant fertilizers, and cultivation bases.

Around 2019, Nurdiawati, et al, came up with a hydrolysis process, by the mixture of α-amylase and protease to hydrolyze feather waste, resulting in a mixture of amino acids, fatty acids, and sugars. Nurdiawati experimented and adopted certain specific high-temperature and high-pressure setting in the hydrolysis process and discovered that the resulting solution, when mixed with some potassium and other minerals, can boost the growth of Pogostemon cablin and Vigna radiata, as reported in International Journal of Recycling or Organic Waste in Agriculture (8:221-232, 2019).

The inventors of present application, under the aegis of CH Biotech, developed different feather and water compositions, performed the hydrolysis at higher temperature (not higher than 200° C.) and higher pressure setting, resulting with a different keratin hydrolysis peptide (“KHP”) solution. The KHP solution can be used on different crops/plants, including the cotton plants that are grown with reduced application of fertilizer, thus boosting the intake/absorption of the fertilizers.

The present invention can choose different mixtures of water and feathers and subject the mixtures to a thermal hydrolysis process to create a solution having molecular mass of 593.3-3,828 Dalton and containing at least 253 peptides as confirmed by using a mass spectrometer.

The inventors used the spectrometer Dionex UltiMate 3000 UPLC to separate the peptides; an analysis is done via Thermo Orbitrap Fushion Lumos Tribrid Orbitrap mass spectrometry to identify the peptides, which are then subsequently confirmed by looking up the BIOPEP-UWM database.

The solution then is applied to the fertilized soil in which the cotton seeds are planted.

The solution can be diluted by water, at 100 to 500 ratio by volume, and then applied to the soil in which the cotton seeds are planted.

A specific water dilution of 1:100 ratio by volume is adopted in carrying out the field tests and has been proven to be effective.

### BRIEF DESCRIPTION OF DRAWINGS

The accompanying drawings, figures and tables, which are incorporated in and constitute a part of this specification, illustrate and exemplify the preferred embodiments of the invention. Together with the description, serve to explain the principles of the invention.

Table I shows the at least 253 peptides and its annotated sequences for the solution generated in accordance with the disclosure of this application.

FIG. 1 shows the comparison of dry weight of the above-ground biomass among the 3 groups: normal, check (CK) and KHP-1.

FIG. 2A shows comparison among the three groups regarding the dry weights of the root systems.

FIG. 2B shows comparison among the three groups regarding the root lengths

### DETAILED DESCRIPTION OF THE INVENTION

The keratin hydrolysis peptide (“KHP”) solution of present invention is made by a high-temperature and high-pressure process to treat a mixture of water and feathers at different weight ratios, and at different temperatures and pressure settings.

The KHP solution herein can be made with three (3) sets of parameters, as disclosed herein.

| | Feather | Water | Water | | | | | |
|---|---|---|---|---|---|---|---|---|
| | Weight | Weight | Content in | Presure | Temp | Time | Mass | Concentr. |
| | (kg) | (kg) | Feathers % | (kg/cm2) | (° C.) | (min) | (Dalton) | (ppm) |
| KHP- | 66 | 44 | 50% | 16 | 195 | 40 | 593.3~3828.0 | 200000 |
| 1 | 50 | 40 | 50% | 12 | 185 | 80 | 593.3~3508.9 | 301500 |
| | 70 | 0 | 46% | 13 | 180 | 40 | 705.9~3194.7 | 381250 |

The hydrolysis process of present invention selected the third parameter (70 kg of feathers, no water) and takes the steps of:
a. Preparing the KHP solution by putting 70 kg of feathers whose content is 46% water in a sealed container;
b. hydrolyzing the mixture in the container with a temperature and pressure setting of 180° C. and 13 kg/cm² for a duration of 40 minutes;
c. using a mass spectrometer to confirm the combination of peptides in the solution to contain at least 253 peptides as listed in the specification where their molecular masses are between 705 and 3,195 Daltons, and the concentration is in the range of 3.0×10⁵˜4.5×10⁵ ppm;
d. applying the solution to lightly fertilized soil around cotton plants.

The confirmation of some of the bioactive 253 peptides is further done by referencing the BIOPEP-UWM database.

The KHP solution made using the third parameter (70 kg of feathers and no water) as described above will be referred to as KHP-1 solution.

The inventors conducted field tests of the KHP-1 solution using the cotton species of Deltapine 1646 B2XF, planted into normal seeding pots where the soil is suitably mixed with a common fertilizer (Taifei Heiwonte 43), with the growth condition of day time temperature 28° C., night time temperature 25° C.; day light hours of 16 and night time hours of 8.

Depending on the fertilizer usage, three (3) groups of cotton planting are carried out: Normal, Check (CK), and KHP-1. There are 9 pots of cotton plants in each group.

The normal group is the 100% fertilizer group where 1.6 g of the common fertilizer is mixed with 100 ml of water and infused into the soil.

The CK group is 50% fertilizer group where 0.8 g of the common fertilizer is mixed with 100 ml of water and infused into the soil. The 50% reduced use of the common fertilizer fits the new benchmark of FUE where even the fertilizer is only lightly used, the plants' growth, development and production are not negatively affected with the application of the KHP solution as disclosed herein.

The KHP-1 group is also 50% fertilizer group where 0.8 g of the common fertilizer is mixed with 100 ml of water, with the addition of 1 ml of KHP-1 solution, and then infused into the soil.

The chart below summarized the fertilizer and the KHP solution usage (100× means dilution by water at ratio of 1:100):

| | Normal | Ck | KHP-1 |
|---|---|---|---|
| KHP-1 | 0 | 0 | 1 ml (100x |
| | | | dilution) |
| Fertilizer | 1.6 g | 0.8 g | 0.8 g |
| Amount | | | |
| Fertilizer | 100% fertilized | 50% fertilized | |
| Grouping | | | |

On the 21^{th} day after the cotton seeds were planted, the young plants from all three groups are then removed from the pots, cleaned off the dirt/soil from the roots and the above-ground portion for taking different measurements as stated below.

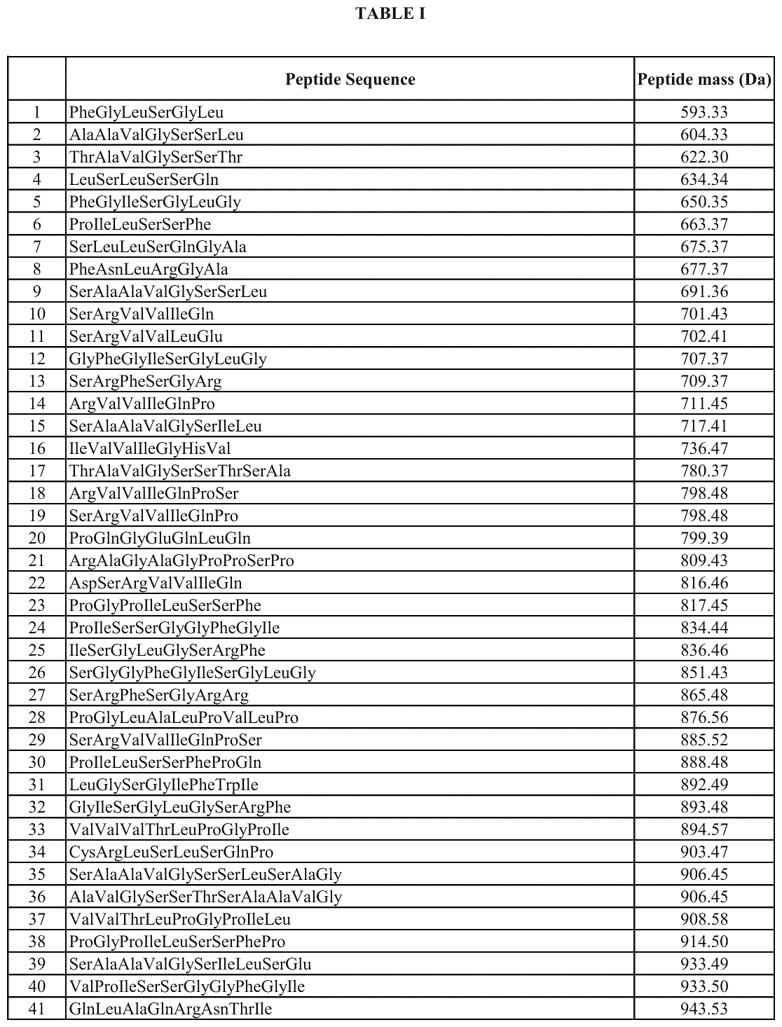

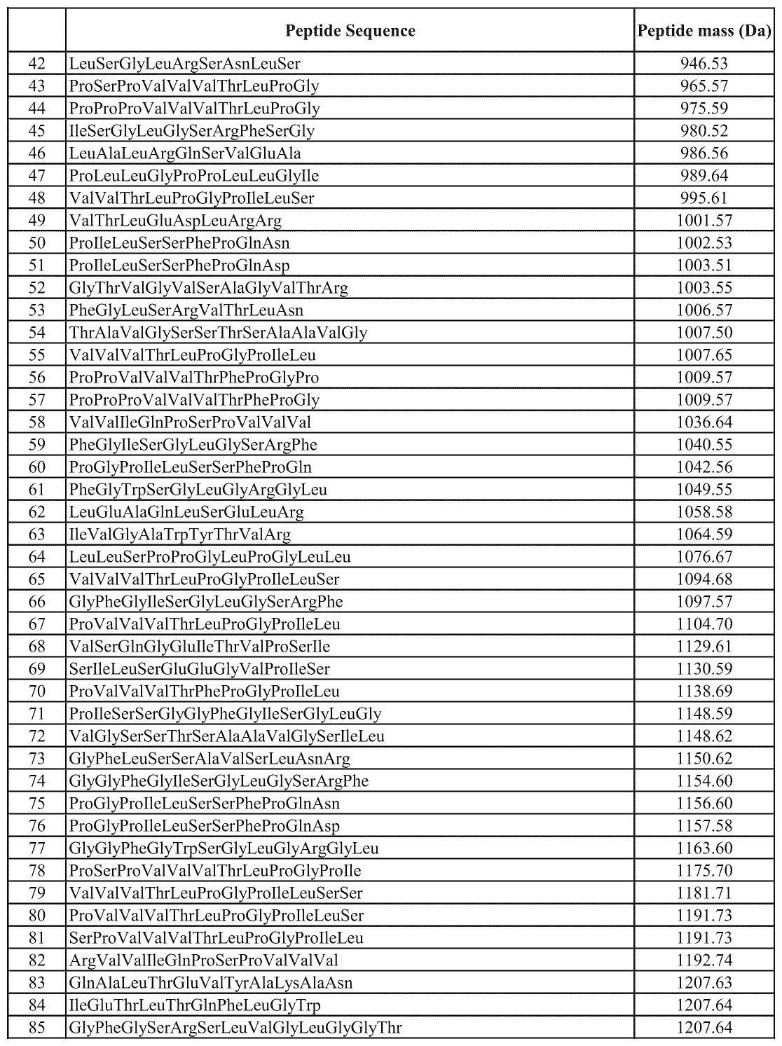

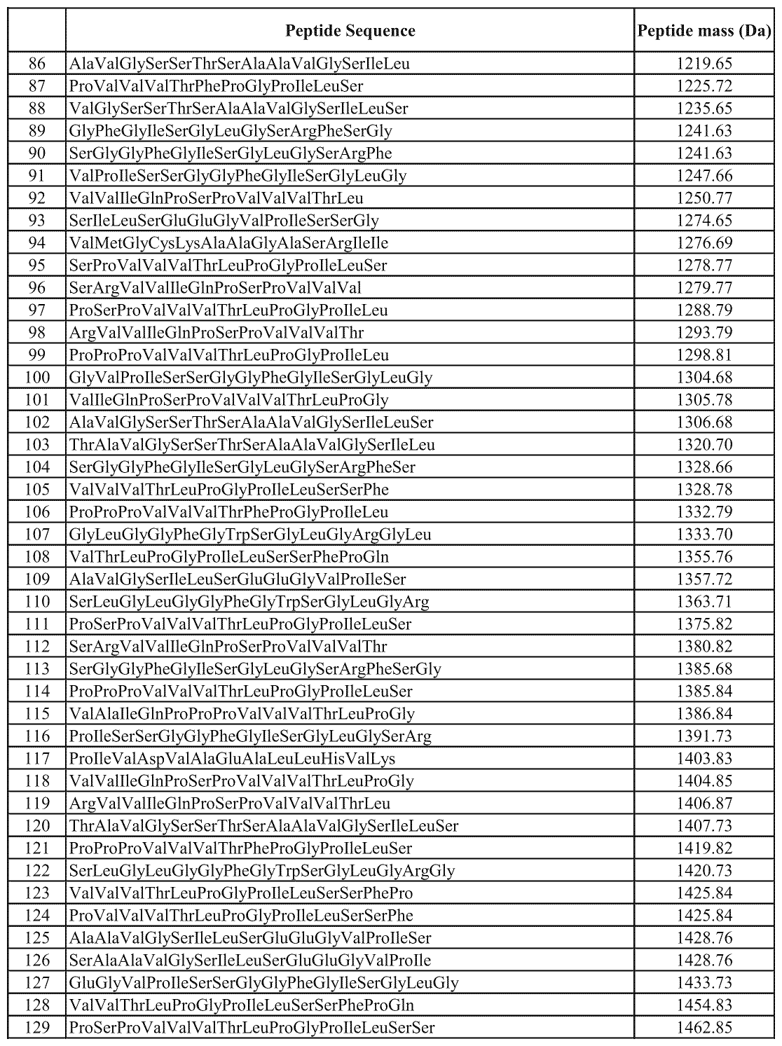

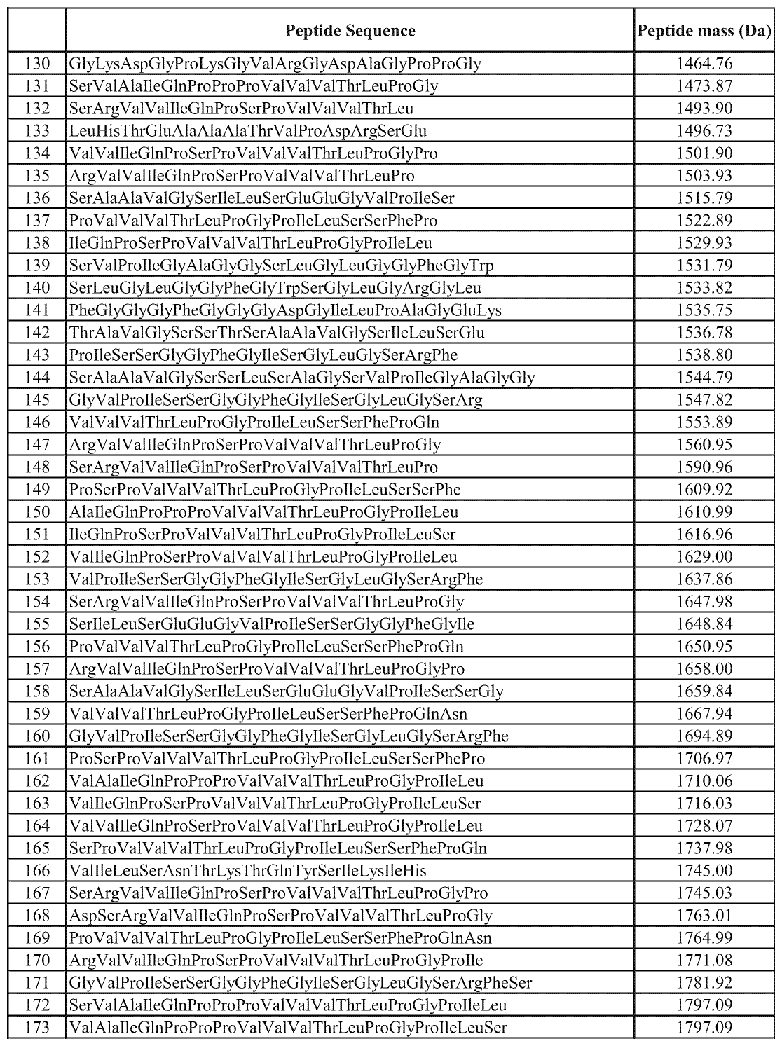

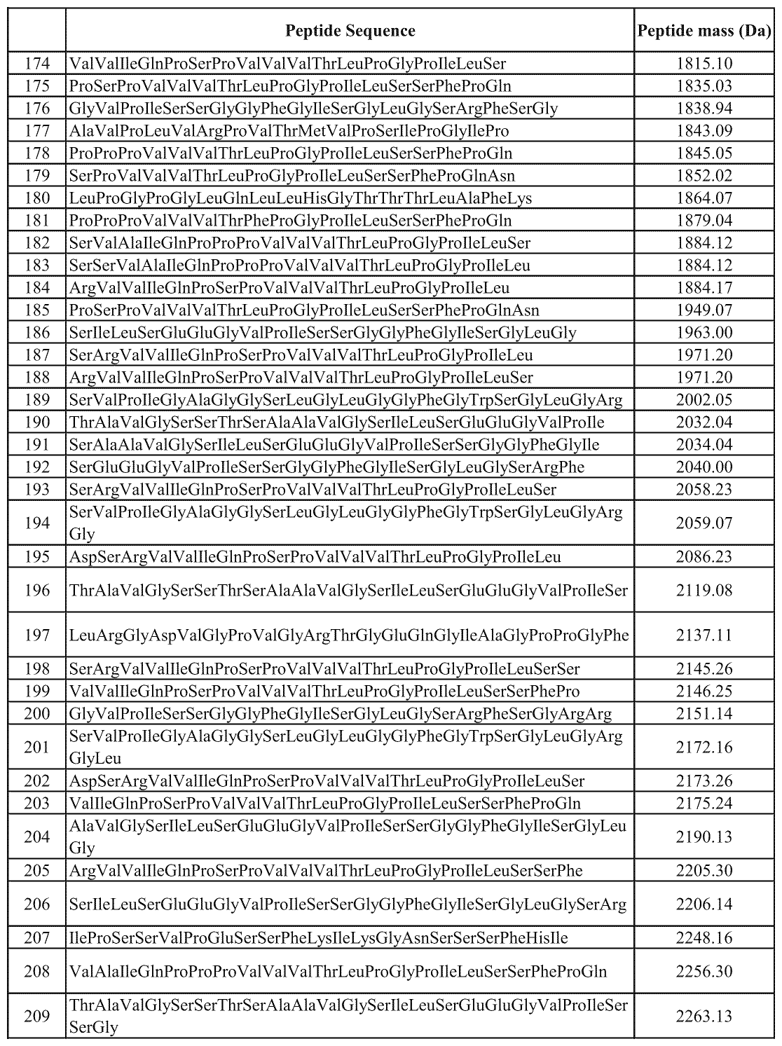

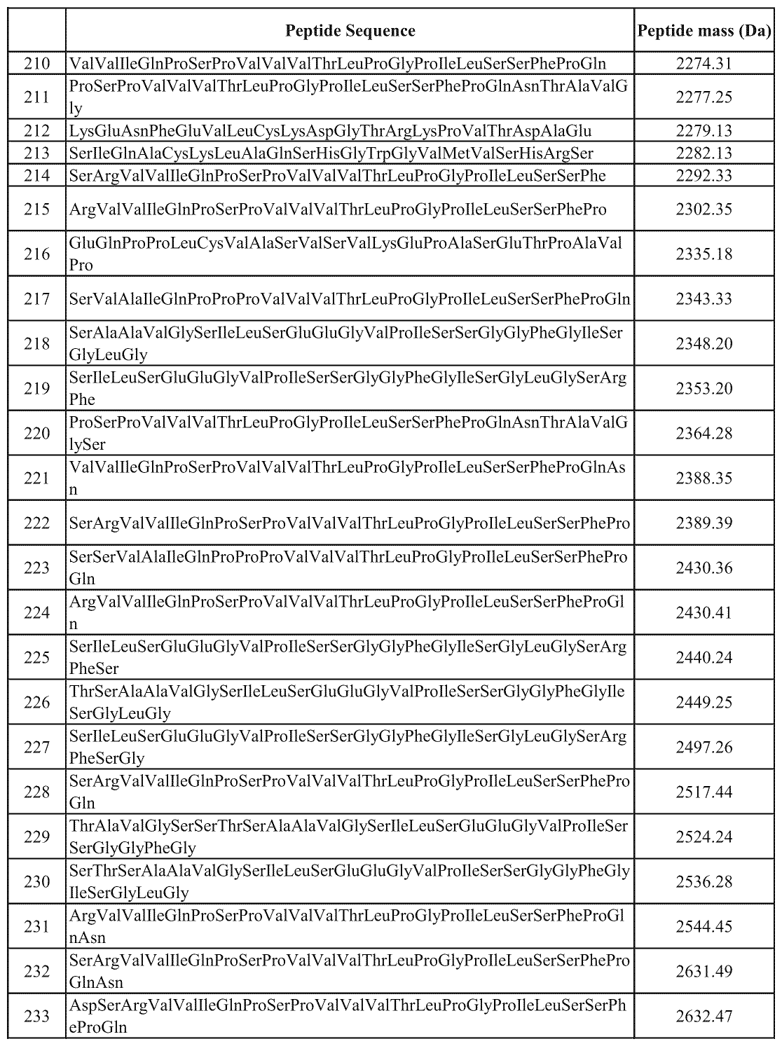

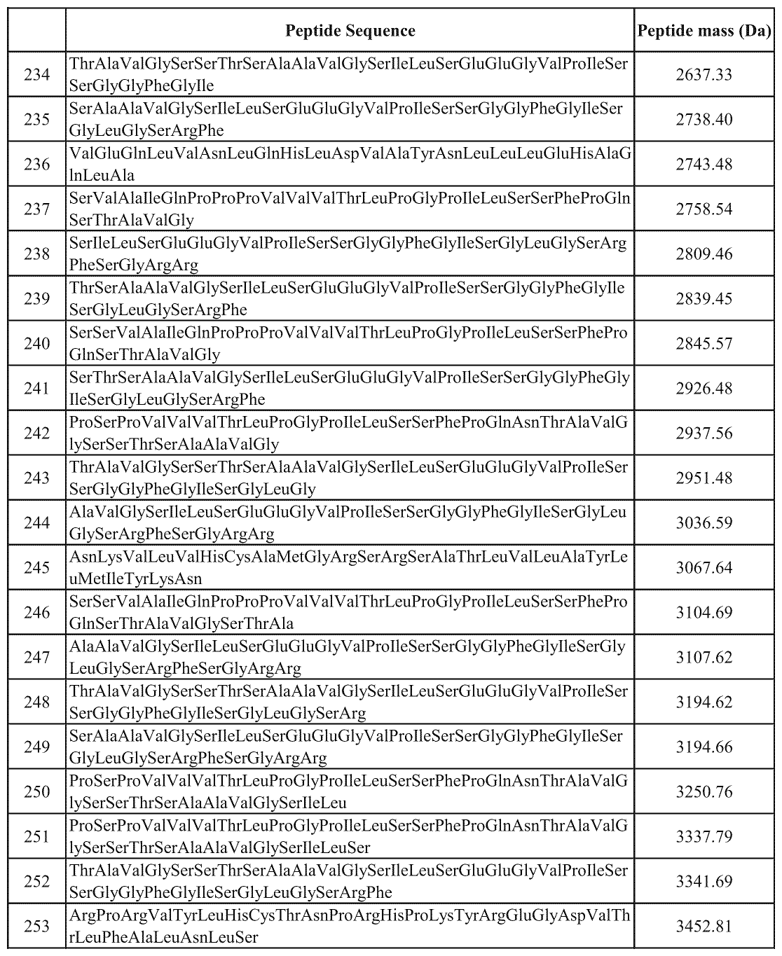

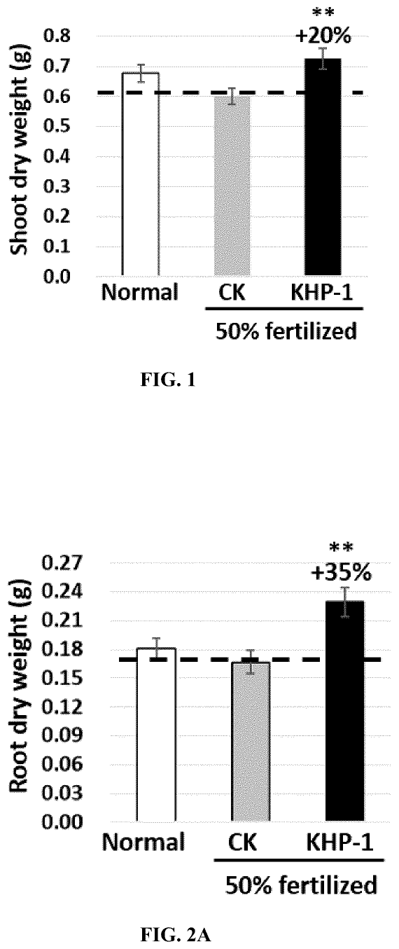

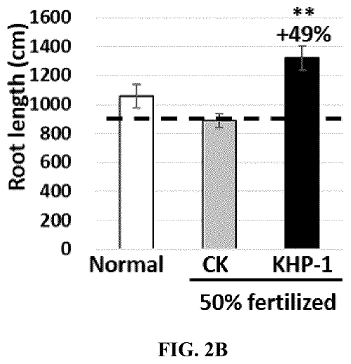

For the above-ground biomass, the dry weights from each group are measured and noted in FIG. 1. It can be seen that the KHP-1 group has 20% more weight than the check group (50% fertilizer used).

For the root system's development, the measurements on dry weights and lengths all show that the use of KHP-1 solution substantially boosted the growth compared to that of the Normal group and of the Check (CK) group.

As has been proven by the field tests, and the scientific analysis/measurement done by the inventors, the method of creating the KHP solution and the method of application to cotton plants, even at 100× dilution, will help with improving the fertilizer efficacy and, consequently, reducing the fertilizer usage overall.

While the disclosure herein gave limited teachings and embodiment examples, it should be noted that the description and disclosure made herein illustrated the preferred embodiments of the invention and are not meant to limit the scope of the applicant's rights. Variations and alterations may be employed for yet additional embodiments without departing from the scope of the invention herein.

TABLE I

| | | Peptide |
|---|---|---|
| | Peptide Sequence | mass (Da) |
| 1 | PheGlyLeuSerGlyLeu | 593.33 |
| 2 | AlaAlaValGlySerSerLeu | 604.33 |
| 3 | ThrAlaValGlySerSerThr | 622.30 |
| 4 | LeuSerLeuSerSerGln | 634.34 |
| 5 | PheGlyIleSerGlyLeuGly | 650.35 |
| 6 | ProIleLeuSerSerPhe | 663.37 |
| 7 | SerLeuLeuSerGlnGlyAla | 675.37 |
| 8 | PheAsnLeuArgGlyAla | 677.37 |
| 9 | SerAlaAlaValGlySerSerLeu | 691.36 |
| 10 | SerArgValValIleGln | 701.43 |
| 11 | SerArgValValLeuGlu | 702.41 |
| 12 | GlyPheGlyIleSerGlyLeuGly | 707.37 |
| 13 | SerArgPheSerGlyArg | 709.37 |
| 14 | ArgValValIleGlnPro | 711.45 |
| 15 | SerAlaAlaValGlySerIleLeu | 717.41 |
| 16 | IleValValIleGlyHisVal | 736.47 |
| 17 | ThrAlaValGlySerSerThrSerAla | 780.37 |
| 18 | ArgValValIleGlnProSer | 798.48 |
| 19 | SerArgValValIleGlnPro | 798.48 |
| 20 | ProGlnGlyGluGlnLeuGln | 799.39 |
| 2 | ArgAlaGlyAlaGlyProProSerPro | 809.43 |
| 22 | AspSerArgValValIleGln | 816.46 |
| 23 | ProGlyProIleLeuSerSerPhe | 817.45 |
| 24 | ProIleSerSerGlyGlyPheGlyIle | 834.44 |
| 25 | IleSerGlyLeuGlySerArgPhe | 836.46 |
| 26 | SerGlyGlyPheGlyIleSerGlyLeuGly | 851.43 |
| 27 | SerArgPheSerGlyArgArg | 865.48 |
| 28 | ProGlyLeuAlaLeuProValLeuPro | 876.56 |
| 29 | SerArgValValIleGlnProSer | 885.52 |
| 30 | ProIleLeuSerSerPheProGln | 888.48 |
| 31 | LeuGlySerGlyIlePheTrpIle | 892.49 |
| 32 | GlyIleSerGlyLeuGlySerArgPhe | 893.48 |
| 33 | ValValValThrLeuProGlyProIle | 894.57 |
| 34 | CysArgLeuSerLeuSerGlnPro | 903.47 |
| 35 | SerAlaAlaValGlySerSerLeuSerAlaGly | 906.45 |
| 36 | AlaValGlySerSerThrSerAlaAlaValGly | 906.45 |
| 37 | ValValThrLeuProGlyProIleLeu | 908.58 |
| 38 | ProGlyProIleLeuSerSerPhePro | 914.50 |
| 39 | SerAlaAlaValGlySerIleLeuSerGlu | 933.49 |
| 40 | ValProIleSerSerGlyGlyPheGlyIle | 933.50 |
| 41 | GlnLeuAlaGlnArgAsnThrIle | 943.53 |
| 42 | LeuSerGlyLeuArgSerAsnLeuSer | 946.53 |
| 43 | ProSerProValValValThrLeuProGly | 965.57 |
| 44 | ProProProValValValThrLeuProGly | 975.59 |
| 45 | IleSerGlyLeuGlySerArgPheSerGly | 980.52 |
| 46 | LeuAlaLeuArgGlnSerValGluAla | 986.56 |
| 47 | ProLeuLeuGlyProProLeuLeuGlyIle | 989.64 |
| 48 | ValValThrLeuProGlyProIleLeuSer | 995.61 |
| 49 | ValThrLeuGluAspLeuArgArg | 1001.57 |
| 50 | ProIleLeuSerSerPheProGlnAsn | 1002.53 |
| 51 | ProIleLeuSerSerPheProGlnAsp | 1003.51 |
| 52 | GlyThrValGlyValSerAlaGlyValThrArg | 1003.55 |
| 53 | PheGlyLeuSerArgValThrLeuAsn | 1006.57 |
| 54 | ThrAlaValGlySerSerThrSerAlaAlaValGly | 1007.50 |
| 55 | ValValValThrLeuProGlyProIleLeu | 1007.65 |
| 56 | ProProValValValThrPheProGlyPro | 1009.57 |
| 57 | ProProProValValValThrPheProGly | 1009.57 |
| 58 | ValValIleGlnProSerProValValVal | 1036.64 |
| 59 | PheGlyIleSerGlyLeuGlySerArgPhe | 1040.55 |
| 60 | ProGlyProIleLeuSerSerPheProGln | 1042.56 |
| 61 | PheGlyTrpSerGlyLeuGlyArgGlyLeu | 1049.55 |
| 62 | LeuGluAlaGlnLeuSerGluLeuArg | 1058.58 |
| 63 | IleValGlyAlaTrpTyrThrValArg | 1064.59 |
| 64 | LeuLeuSerProProGlyLeuProGlyLeuLeu | 1076.67 |
| 65 | ValValValThrLeuProGlyProIleLeuSer | 1094.68 |
| 66 | GlyPheGlyIleSerGlyLeuGlySerArgPhe | 1097.57 |
| 67 | ProValValValThrLeuProGlyProIleLeu | 1104.70 |
| 68 | ValSerGlnGlyGluIleThrValProSerIle | 1129.61 |
| 69 | SerIleLeuSerGluGluGlyValProIleSer | 1130.59 |
| 70 | ProValValValThrPheProGlyProIleLeu | 1138.69 |
| 71 | ProIleSerSerGlyGlyPheGlyIleSerGlyLeuGly | 1148.59 |
| 72 | ValGlySerSerThrSerAlaAlaValGlySerIleLeu | 1148.62 |
| 73 | GlyPheLeuSerSerAlaValSerLeuAsnArg | 1150.62 |
| 74 | GlyGlyPheGlyIleSerGlyLeuGlySerArgPhe | 1154.60 |
| 75 | ProGlyProIleLeuSerSerPheProGlnAsn | 1156.60 |
| 76 | ProGlyProIleLeuSerSerPheProGlnAsp | 1157.58 |
| 77 | GlyGlyPheGlyTrpSerGlyLeuGlyArgGlyLeu | 1163.60 |
| 78 | ProSerProValValValThrLeuProGlyProIle | 1175.70 |
| 79 | ValValValThrLeuProGlyProIleLeuSerSer | 1181.71 |
| 80 | ProValValValThrLeuProGlyProIleLeuSer | 1191.73 |
| 81 | SerProValValValThrLeuProGlyProIleLeu | 1191.73 |
| 82 | ArgValValIleGlnProSerProValValVal | 1192.74 |
| 83 | GlnAlaLeuThrGluValTyrAlaLysAlaAsn | 1207.63 |
| 84 | IleGluThrLeuThrGlnPheLeuGlyTrp | 1207.64 |
| 85 | GlyPheGlySerArgSerLeuValGlyLeuGlyGlyThr | 1207.64 |
| 86 | AlaValGlySerSerThrSerAlaAlaValGlySerIleLeu | 1219.65 |
| 87 | ProValValValThrPheProGlyProIleLeuSer | 1225.72 |
| 88 | ValGlySerSerThrSerAlaAlaValGlySerIleLeuSer | 1235.65 |
| 89 | GlyPheGlyIleSerGlyLeuGlySerArgPheSerGly | 1241.63 |
| 90 | SerGlyGlyPheGlyIleSerGlyLeuGlySerArgPhe | 1241.63 |
| 91 | ValProIleSerSerGlyGlyPheGlyIleSerGlyLeuGly | 1247.66 |
| 92 | ValValIleGlnProSerProValValValThrLeu | 1250.77 |
| 93 | SerIleLeuSerGluGluGlyValProIleSerSerGly | 1274.65 |
| 94 | ValMetGlyCysLysAlaAlaGlyAlaSerArgIleIle | 1276.69 |
| 95 | SerProValValValThrLeuProGlyProIleLeuSer | 1278.77 |
| 96 | SerArgValValIleGlnProSerProValValVal | 1279.77 |
| 97 | ProSerProValValValThrLeuProGlyProIleLeu | 1288.79 |
| 98 | ArgValValIleGlnProSerProValValValThr | 1293.79 |
| 99 | ProProProValValValThrLeuProGlyProIleLeu | 1298.81 |
| 100 | GlyValProIleSerSerGlyGlyPheGlyIleSerGlyLeuGly | 1304.68 |
| 101 | ValIleGlnProSerProValValValThrLeuProGly | 1305.78 |
| 102 | AlaValGlySerSerThrSerAlaAlaValGlySerIleLeuSer | 1306.68 |
| 103 | ThrAlaValGlySerSerThrSerAlaAlaValGlySerIleLeu | 1320.70 |
| 104 | SerGlyGlyPheGlyIleSerGlyLeuGlySerArgPheSer | 1328.66 |
| 105 | ValValValThrLeuProGlyProIleLeuSerSerPhe | 1328.78 |
| 106 | ProProProValValValThrPheProGlyProIleLeu | 1332.79 |
| 107 | GlyLeuGlyGlyPheGlyTrpSerGlyLeuGlyArgGlyLeu | 1333.70 |
| 108 | ValThrLeuProGlyProIleLeuSerSerPheProGln | 1355.76 |
| 109 | AlaValGlySerIleLeuSerGluGluGlyValProIleSer | 1357.72 |
| 110 | SerLeuGlyLeuGlyGlyPheGlyTrpSerGlyLeuGlyArg | 1363.71 |
| 111 | ProSerProValValValThrLeuProGlyProIleLeuSer | 1375.82 |
| 112 | SerArgValValIleGlnProSerProValValValThr | 1380.82 |
| 113 | SerGlyGlyPheGlyIleSerGlyLeuGlySerArgPheSerGly | 1385.68 |
| 114 | ProProProValValValThrLeuProGlyProIleLeuSer | 1385.84 |
| 115 | ValAlaIleGlnProProProValValValThrLeuProGly | 1386.84 |
| 116 | ProIleSerSerGlyGlyPheGlyIleSerGlyLeuGlySerArg | 1391.73 |
| 117 | ProIleValAspValAlaGluAlaLeuLeuHisValLys | 1403.83 |
| 118 | ValValIleGlnProSerProValValValThrLeuProGly | 1404.85 |
| 119 | ArgValValIleGlnProSerProValValValThrLeu | 1406.87 |
| 120 | ThrAlaValGlySerSerThrSerAlaAlaValGlySerIleLeuSer | 1407.73 |
| 121 | ProProProValValValThrPheProGlyProIleLeuSer | 1419.82 |
| 122 | SerLeuGlyLeuGlyGlyPheGlyTrpSerGlyLeuGlyArgGly | 1420.73 |
| 123 | ValValValThrLeuProGlyProIleLeuSerSerPhePro | 1425.84 |
| 124 | ProValValValThrLeuProGlyProIleLeuSerSerPhe | 1425.84 |
| 125 | AlaAlaValGlySerIleLeuSerGluGluGlyValProIleSer | 1428.76 |
| 126 | SerAlaAlaValGlySerIleLeuSerGluGluGlyValProIle | 1428.76 |
| 127 | GluGlyValProIleSerSerGlyGlyPheGlyIleSerGlyLeuGly | 1433.73 |
| 128 | ValValThrLeuProGlyProIleLeuSerSerPheProGln | 1454.83 |
| 129 | ProSerProValValValThrLeuProGlyProIleLeuSerSer | 1462.85 |
| 130 | GlyLysAspGlyProLysGlyValArgGlyAspAlaGlyProProGly | 1464.76 |
| 131 | SerValAlaIleGlnProProProValValValThrLeuProGly | 1473.87 |
| 132 | SerArgValValIleGlnProSerProValValValThrLeu | 1493.90 |
| 133 | LeuHisThrGluAlaAlaAlaThrValProAspArgSerGlu | 1496.73 |
| 134 | ValValIleGlnProSerProValValValThrLeuProGlyPro | 1501.90 |
| 135 | ArgValValIleGlnProSerProValValValThrLeuPro | 1503.93 |
| 136 | SerAlaAlaValGlySerIleLeuSerGluGluGlyValProIleSer | 1515.79 |
| 137 | ProValValValThrLeuProGlyProIleLeuSerSerPhePro | 1522.89 |
| 138 | IleGlnProSerProValValValThrLeuProGlyProIleLeu | 1529.93 |
| 139 | SerValProIleGlyAlaGlyGlySerLeuGlyLeuGlyGlyPheGlyTrp | 1531.79 |
| 140 | SerLeuGlyLeuGlyGlyPheGlyTrpSerGlyLeuGlyArgGlyLeu | 1533.82 |
| 141 | PheGlyGlyGlyPheGlyGlyGlyAspGlyIleLeuProAlaGlyGluLys | 1535.75 |
| 142 | ThrAlaValGlySerSerThrSerAlaAlaValGlySerIleLeuSerGlu | 1536.78 |
| 143 | ProIleSerSerGlyGlyPheGlyIleSerGlyLeuGlySerArgPhe | 1538.80 |
| 144 | SerAlaAlaValGlySerSerLeuSerAlaGlySerValProIleGlyAlaGlyGly | 1544.79 |
| 145 | GlyValProIleSerSerGlyGlyPheGlyIleSerGlyLeuGlySerArg | 1547.82 |
| 146 | ValValValThrLeuProGlyProIleLeuSerSerPheProGln | 1553.89 |
| 147 | ArgValValIleGlnProSerProValValValThrLeuProGly | 1560.95 |
| 148 | SerArgValValIleGlnProSerProValValValThrLeuPro | 1590.96 |
| 149 | ProSerProValValValThrLeuProGlyProIleLeuSerSerPhe | 1609.92 |
| 150 | AlaIleGlnProProProValValValThrLeuProGlyProIleLeu | 1610.99 |
| 151 | IlcGlnProSerProValValValThrLeuProGlyProIleLeuSer | 1616.96 |
| 152 | ValIleGlnProSerProValValValThrLeuProGlyProIleLeu | 1629.00 |
| 153 | ValProIleSerSerGlyGlyPheGlyIleSerGlyLeuGlySerArgPhe | 1637.86 |
| 154 | SerArgValValIleGlnProSerProValValValThrLeuProGly | 1647.98 |
| 155 | SerIleLeuSerGluGluGlyValProIleSerSerGlyGlyPheGlyIle | 1648.84 |
| 156 | ProValValValThrLeuProGlyProIleLeuSerSerPheProGln | 1650.95 |
| 157 | ArgValValIleGlnProSerProValValValThrLeuProGlyPro | 1658.00 |
| 158 | SerAlaAlaValGlySerIleLeuSerGluGluGlyValProIleSerSerGly | 1659.84 |
| 159 | ValValValThrLeuProGlyProIleLeuSerSerPheProGlnAsn | 1667.94 |
| 160 | GlyValProIleSerSerGlyGlyPheGlyIleSerGlyLeuGlySerArgPhe | 1694.89 |
| 161 | ProSerProValValValThrLeuProGlyProIleLeuSerSerPhePro | 1706.97 |
| 162 | ValAlaIleGlnProProProValValValThrLeuProGlyProIleLeu | 1710.06 |
| 163 | ValIleGlnProSerProValValValThrLeuProGlyProIleLeuSer | 1716.03 |
| 164 | ValValIleGlnProSerProValValValThrLeuProGlyProIleLeu | 1728.07 |
| 165 | SerProValValValThrLeuProGlyProIleLeuSerSerPheProGln | 1737.98 |
| 166 | ValIleLeuSerAsnThrLysThrGlnTyrSerIleLysIleHis | 1745.00 |
| 167 | SerArgValValIleGlnProSerProValValValThrLeuProGlyPro | 1745.03 |
| 168 | AspSerArgValValIleGlnProSerProValValValThrLeuProGly | 1763.01 |
| 169 | ProValValValThrLeuProGlyProIleLeuSerSerPheProGlnAsn | 1764.99 |
| 170 | ArgValValIleGlnProSerProValValValThrLeuProGlyProIle | 1771.08 |
| 171 | GlyValProIleSerSerGlyGlyPheGlyIleSerGlyLeuGlySerArgPheSer | 1781.92 |
| 172 | SerValAlaIleGlnProProProValValValThrLeuProGlyProIleLeu | 1797.09 |
| 173 | ValAlaIleGlnProProProValValValThrLeuProGlyProIleLeuSer | 1797.09 |
| 174 | ValValIleGlnProSerProValValValThrLeuProGlyProIleLeuSer | 1815.10 |
| 175 | ProSerProValValValThrLeuProGlyProIleLeuSerSerPheProGln | 1835.03 |
| 176 | GlyValProIleSerSerGlyGlyPheGlyIleSerGlyLeuGlySerArgPheSerGly | 1838.94 |
| 177 | AlaValProLeuValArgProValThrMetValProSerIleProGlyIlePro | 1843.09 |
| 178 | ProProProValValValThrLeuProGlyProIleLeuSerSerPheProGln | 1845.05 |
| 179 | SerProValValValThrLeuProGlyProIleLeuSerSerPheProGlnAsn | 1852.02 |
| 180 | LeuProGlyProGlyLeuGlnLeuLeuHisGlyThrThrThrLeuAlaPheLys | 1864.07 |
| 181 | ProProProValValValThrPheProGlyProIleLeuSerSerPheProGln | 1879.04 |
| 182 | SerValAlaIleGlnProProProValValValThrLeuProGlyProIleLeuSer | 1884.12 |
| 183 | SerSerValAlaIleGlnProProProValValValThrLeuProGlyProIleLeu | 1884.12 |
| 184 | ArgValValIleGlnProSerProValValValThrLeuProGlyProIleLeu | 1884.17 |
| 185 | ProSerProValValValThrLeuProGlyProIleLeuSerSerPheProGlnAsn | 1949.07 |
| 186 | SerIleLeuSerGluGluGlyValProIleSerSerGlyGlyPheGlyIleSerGlyLeuGly | 1963.00 |
| 187 | SerArgValValIleGlnProSerProValValValThrLeuProGlyProIleLeu | 1971.20 |
| 188 | ArgValValIleGlnProSerProValValValThrLeuProGlyProIleLeuSer | 1971.20 |
| 189 | SerValProIleGlyAlaGlyGlySerLeuGlyLeuGlyGlyPheGlyTrpSerGlyLeuGlyArg | 2002.05 |
| 190 | ThrAlaValGlySerSerThrSerAlaAlaValGlySerIleLeuSerGluGluGlyValProIle | 2032.04 |
| 191 | SerAlaAlaValGlySerIleLeuSerGluGluGlyValProIleSerSerGlyGlyPheGlyIle | 2034.04 |
| 192 | SerGluGluGlyValProIleSerSerGlyGlyPheGlyIleSerGlyLeuGlySerArgPhe | 2040.00 |
| 193 | SerArgValValIleGlnProSerProValValValThrLeuProGlyProIleLeuSer | 2058.23 |
| 194 | SerValProIleGlyAlaGlyGlySerLeuGlyLeuGlyGlyPheGlyTrpSerGlyLeuGlyArg | 2059.07 |
| | Gly | |
| 195 | AspSerArgValValIleGlnProSerProValValValThrLeuProGlyProIleLeu | 2086.23 |
| 196 | ThrAlaValGlySerSerThrSerAlaAlaValGlySerIleLeuSerGluGluGlyValProIleSer | 2119.08 |
| 197 | LeuArgGlyAspValGlyProValGlyArgThrGlyGluGlnGlyIleAlaGlyProProGlyPhe | 2137.11 |
| 198 | SerArgValValIleGlnProSerProValValValThrLeuProGlyProIleLeuSerSer | 2145.26 |
| 199 | ValValIleGlnProSerProValValValThrLeuProGlyProIleLeuSerSerPhePro | 2146.25 |
| 200 | GlyValProIleSerSerGlyGlyPheGlyIleSerGlyLeuGlySerArgPheSerGlyArgArg | 2151.14 |
| 201 | SerValProIleGlyAlaGlyGlySerLeuGlyLeuGlyGlyPheGlyTrpSerGlyLeuGlyArg | 2172.16 |
| | GlyLeu | |
| 202 | AspSerArgValValIleGlnProSerProValValValThrLeuProGlyProIleLeuSer | 2173.26 |
| 203 | ValIleGlnProSerProValValValThrLeuProGlyProIleLeuSerSerPheProGln | 2175.24 |
| 204 | AlaValGlySerIleLcuSerGluGluGlyValProIleSerSerGlyGlyPheGlyIleSerGlyLeu | 2190.13 |
| | Gly | |
| 205 | ArgValValIleGlnProSerProValValValThrLeuProGlyProIleLeuSerSerPhe | 2205.30 |
| 206 | SerIleLeuSerGluGluGlyValProIleSerSerGlyGlyPheGlyIleSerGlyLeuGlySerArg | 2206.14 |
| 207 | IleProSerSerValProGluSerSerPheLysIleLysGlyAsnSerSerSerPheHisIle | 2248.16 |
| 208 | ValAlaIleGlnProProProValValValThrLcuProGlyProIleLeuSerSerPheProGln | 2256.30 |
| 209 | ThrAlaValGlySerSerThrSerAlaAlaValGlySerIleLeuSerGluGluGlyValProIleSer | 2263.13 |
| | SerGly | |
| 210 | ValValIleGlnProSerProValValValThrLeuProGlyProIleLeuSerSerPheProGln | 2274.31 |
| 211 | ProSerProValValValThrLeuProGlyProIleLeuSerSerPheProGlnAsnThrAlaVal | 2277.25 |
| | Gly | |
| 212 | LysGluAsnPheGluValLeuCysLysAspGlyThrArgLysProValThrAspAlaGlu | 2279.13 |
| 213 | SerIleGlnAlaCysLysLeuAlaGlnSerHisGlyTrpGlyValMetValSerHisArgSer | 2282.13 |
| 214 | SerArgValValIleGlnProSerProValValValThrLeuProGlyProIleLeuSerSerPhe | 2292.33 |
| 215 | ArgValValIleGlnProSerProValValValThrLeuProGlyProIleLeuSerSerPhePro | 2302.35 |
| 216 | GluGlnProProLeuCysValAlaSerValSerValLysGluProAlaSerGluThrProAlaVal | 2335.18 |
| | Pro | |
| 217 | SerValAlaIleGlnProProProValValValThrLeuProGlyProIleLeuSerSerPheProGln | 2343.33 |
| 218 | SerAlaAlaValGlySerIleLeuSerGluGluGlyValProIleSerSerGlyGlyPheGlyIleSer | 2348.20 |
| | GlyLeuGly | |
| 219 | SerIleLeuSerGluGluGlyValProIleSerSerGlyGlyPheGlyIleSerGlyLeuGlySerArg | 2353.20 |
| | Phe | |
| 220 | ProSerProValValValThrLeuProGlyProIleLeuSerSerPheProGlnAsnThrAlaVal | 2364.28 |
| | GlySer | |
| 221 | ValValIleGlnProSerProValValValThrLeuProGlyProIleLeuSerSerPheProGln | 2388.35 |
| | Asn | |
| 222 | SerArgValValIleGlnProSerProValValValThrLeuProGlyProIleLeuSerSerPhePro | 2389.39 |
| 223 | SerSerValAlaIleGlnProProProValValValThrLeuProGlyProIleLeuSerSerPhePro | 2430.36 |
| | Gln | |
| 224 | ArgValValIleGlnProSerProValValValThrLeuProGlyProIleLeuSerSerPhePro | 2430.41 |
| | Gln | |
| 225 | SerIleLeuSerGluGluGlyValProIleSerSerGlyGlyPheGlyIleSerGlyLeuGlySerArg | 2440.24 |
| | PheSer | |
| 226 | ThrSerAlaAlaValGlySerIleLeuSerGluGluGlyValProIleSerSerGlyGlyPheGlyIle | 2449.25 |
| | SerGlyLeuGly | |
| 227 | SerIleLeuSerGluGluGlyValProIleSerSerGlyGlyPheGlyIleSerGlyLeuGlySerArg | 2497.26 |
| | PheSerGly | |
| 228 | SerArgValValIleGlnProSerProValValValThrLeuProGlyProIleLeuSerSerPhePro | 2517.44 |
| | Gln | |
| 229 | ThrAlaValGlySerSerThrSerAlaAlaValGlySerIleLeuSerGluGluGlyValProIleSer | 2524.24 |
| | SerGlyGlyPheGly | |
| 230 | SerThrSerAlaAlaValGlySerIleLeuSerGluGluGlyValProIleSerSerGlyGlyPheGly | 2536.28 |
| | IleSerGlyLeuGly | |
| 231 | ArgValValIleGlnProSerProValValValThrLeuProGlyProIleLeuSerSerPhePro | 2544.45 |
| | GlnAsn | |
| 232 | SerArgValValIleGlnProSerProValValValThrLeuProGlyProIleLeuSerSerPhePro | 2631.49 |
| | GlnAsn | |
| 233 | AspSerArgValValIleGlnProSerProValValValThrLeuProGlyProIleLeuSerSer | 2632.47 |
| | PheProGln | |
| 234 | ThrAlaValGlySerSerThrSerAlaAlaValGlySerIleLeuSerGluGluGlyValProIleSer | 2637.33 |
| | SerGlyGlyPheGlyIle | |
| 235 | SerAlaAlaValGlySerIleLeuSerGluGluGlyValProIleSerSerGlyGlyPheGlyIleSer | 2738.40 |
| | GlyLeuGlySerArgPhe | |
| 236 | ValGluGlnLeuValAsnLeuGlnHisLcuAspValAlaTyrAsnLeuLeuLeuGluHisAla | 2743.48 |
| | GlnLeuAla | |
| 237 | SerValAlaIleGlnProProProValValValThrLeuProGlyProIleLeuSerSerPheProGln | 2758.54 |
| | SerThrAlaValGly | |
| 238 | SerIleLeuSerGluGluGlyValProIleSerSerGlyGlyPheGlyIleSerGlyLeuGlySerArg | 2809.46 |
| | PheSerGlyArgArg | |
| 239 | ThrSerAlaAlaValGlySerIleLeuSerGluGluGlyValProIleSerSerGlyGlyPheGlyIle | 2839.45 |
| | SerGlyLeuGlySerArgPhe | |
| 240 | SerSerValAlaIleGlnProProProValValValThrLeuProGlyProIleLeuSerSerPhePro | 2845.57 |
| | GlnSerThrAlaValGly | |
| 241 | SerThrSerAlaAlaValGlySerIleLeuSerGluGluGlyValProIleSerSerGlyGlyPheGly | 2926.48 |
| | IleSerGlyLeuGlySerArgPhe | |
| 242 | ProSerProValValValThrLeuProGlyProIleLeuSerSerPheProGlnAsnThrAlaVal | 2937.56 |
| | GlySerSerThrSerAlaAlaValGly | |
| 243 | ThrAlaValGlySerSerThrSerAlaAlaValGlySerIleLcuSerGluGluGlyValProIleSer | 2951.48 |
| | SerGlyGlyPheGlyIleSerGlyLeuGly | |
| 244 | AlaValGlySerIleLeuSerGluGluGlyValProIleSerSerGlyGlyPheGlyIleSerGlyLeu | 3036.59 |
| | GlySerArgPheSerGlyArgArg | |
| 245 | AsnLysValLeuValHisCysAlaMetGlyArgSerArgSerAlaThrLeuValLeuAlaTyr | 3067.64 |
| | LeuMetIleTyrLysAsn | |
| 246 | SerSerValAlaIleGlnProProProValValValThrLeuProGlyProIleLeuSerSerPhePro | 3104.69 |
| | GlnSerThrAlaValGlySerThrAla | |
| 247 | AlaAlaValGlySerIleLeuSerGluGluGlyValProIleSerSerGlyGlyPheGlyIleSerGly | 3107.62 |
| | LeuGlySerArgPheSerGlyArgArg | |
| 248 | ThrAlaValGlySerSerThrSerAlaAlaValGlySerIleLeuSerGluGluGlyValProIleSer | 3194.62 |
| | SerGlyGlyPheGlyIIleSerGlyLeuGlySerArg | |
| 249 | SerAlaAlaValGlySerIleLeuSerGluGluGlyValProIleSerSerGlyGlyPheGlyIleSer | 3194.66 |
| | GlyLeuGlySerArgPheSerGlyArgArg | |
| 250 | ProSerProValValValThrLeuProGlyProIleLeuSerSerPheProGlnAsnThrAlaVal | 3250.76 |
| | GlySerSerThrSerAlaAlaValGlySerIleLeu | |
| 251 | ProSerProValValValThrLeuProGlyProIleLeuSerSerPheProGlnAsnThrAlaVal | 3337.79 |
| | GlySerSerThrSerAlaAlaValGlySerIleLeuSer | |
| 252 | ThrAlaValGlySerSerThrSerAlaAlaValGlySerIleLeuSerGluGluGlyValProIleSer | 3341.69 |
| | SerGlyGlyPheGlyIleSerGlyLeuGlySerArgPhe | |
| 253 | ArgProArgValTyrLeuHisCysThrAsnProArgHisProLysTyrArgGluGlyAspVal | 3452.81 |
| | ThrLeuPheAlaLeuAsnLeuSer | |

The invention claimed is:

1. A method of using a keratin hydrolysis peptide (KHP) solution to a cotton plant for the enhancement of the cotton plant's fertilizer absorption efficacy, comprising the steps of:
a. Preparing the KHP solution mixture by putting 70 kg of feathers whose content is 46% water in a sealed container;
b. hydrolyzing the mixture in the container with a temperature and pressure setting of 180° C. and 13 kg/cm² for a duration of 40 minutes;
c. using a mass spectrometer to confirm the combination of peptides in the solution to contain at least 253 peptides as listed in the specification where their molecular masses are between 705 and 3,195 Daltons, and the concentration is in the range of 3.0×10⁵˜4.5×10⁵ ppm;
d. applying the solution to lightly fertilized soil around cotton plants.

2. The method of using a keratin hydrolysis peptide (KHP) solution of claim 1 where the solution is diluted with water by volume at the ratio of 1:100-500 and is infused into the lightly fertilized soil around the planted cotton.

3. The method of using a keratin hydrolysis peptide (KHP) solution of claim 1 where the solution is diluted with water by volume at the ratio of 1:100 for applying to the lightly fertilized soil in which the cotton seeds are planted.


SEQUENCE LISTING (253 sequences)

SEQ ID NO: 1 - protein, 6 aa, Gallus gallus
FGLSGL

SEQ ID NO: 2 - protein, 7 aa, Gallus gallus
AAVGSSL

SEQ ID NO: 3 - protein, 7 aa, Gallus gallus
TAVGSST

SEQ ID NO: 4 - protein, 6 aa, Gallus gallus
LSLSSQ

SEQ ID NO: 5 - protein, 7 aa, Gallus gallus
FGISGLG

SEQ ID NO: 6 - protein, 6 aa, Gallus gallus
PILSSF

SEQ ID NO: 7 - protein, 7 aa, Gallus gallus
SLLSQGA

SEQ ID NO: 8 - protein, 6 aa, Gallus gallus
FNLRGA

SEQ ID NO: 9 - protein, 8 aa, Gallus gallus
SAAVGSSL

SEQ ID NO: 10 - protein, 6 aa, Gallus gallus
SRVVIQ

SEQ ID NO: 11 - protein, 6 aa, Gallus gallus
SRVVLE

SEQ ID NO: 12 - protein, 8 aa, Gallus gallus
GFGISGLG

SEQ ID NO: 13 - protein, 6 aa, Gallus gallus
SRFSGR

SEQ ID NO: 14 - protein, 6 aa, Gallus gallus
RVVIQP

SEQ ID NO: 15 - protein, 8 aa, Gallus gallus
SAAVGSIL

SEQ ID NO: 16 - protein, 7 aa, Gallus gallus
IVVIGHV

SEQ ID NO: 17 - protein, 9 aa, Gallus gallus
TAVGSSTSA

SEQ ID NO: 18 - protein, 7 aa, Gallus gallus
RVVIQPS

SEQ ID NO: 19 - protein, 7 aa, Gallus gallus
SRVVIQP

SEQ ID NO: 20 - protein, 7 aa, Gallus gallus
PQGEQLQ

SEQ ID NO: 21 - protein, 9 aa, Gallus gallus
RAGAGPPSP

SEQ ID NO: 22 - protein, 7 aa, Gallus gallus
DSRVVIQ

SEQ ID NO: 23 - protein, 8 aa, Gallus gallus
PGPILSSF

SEQ ID NO: 24 - protein, 9 aa, Gallus gallus
PISSGGFGI

SEQ ID NO: 25 - protein, 8 aa, Gallus gallus
ISGLGSRF

SEQ ID NO: 26 - protein, 10 aa, Gallus gallus
SGGFGISGLG

SEQ ID NO: 27 - protein, 7 aa, Gallus gallus
SRFSGRR

SEQ ID NO: 28 - protein, 9 aa, Gallus gallus
PGLALPVLP

SEQ ID NO: 29 - protein, 8 aa, Gallus gallus
SRVVIQPS

SEQ ID NO: 30 - protein, 8 aa, Gallus gallus
PILSSFPQ

SEQ ID NO: 31 - protein, 8 aa, Gallus gallus
LGSGIFWI

SEQ ID NO: 32 - protein, 9 aa, Gallus gallus
GISGLGSRF

SEQ ID NO: 33 - protein, 9 aa, Gallus gallus
VVVTLPGPI

SEQ ID NO: 34 - protein, 8 aa, Gallus gallus
CRLSLSQP

SEQ ID NO: 35 - protein, 11 aa, Gallus gallus
SAAVGSSLSAG

SEQ ID NO: 36 - protein, 11 aa, Gallus gallus
AVGSSTSAAVG

SEQ ID NO: 37 - protein, 9 aa, Gallus gallus
VVTLPGPIL

SEQ ID NO: 38 - protein, 9 aa, Gallus gallus
PGPILSSFP

SEQ ID NO: 39 - protein, 10 aa, Gallus gallus
SAAVGSILSE

SEQ ID NO: 40 - protein, 10 aa, Gallus gallus
VPISSGGFGI

SEQ ID NO: 41 - protein, 8 aa, Gallus gallus
QLAQRNTI

SEQ ID NO: 42 - protein, 9 aa, Gallus gallus
LSGLRSNLS

SEQ ID NO: 43 - protein, 10 aa, Gallus gallus
PSPVVVTLPG

SEQ ID NO: 44 - protein, 10 aa, Gallus gallus
PPPVVVTLPG

SEQ ID NO: 45 - protein, 10 aa, Gallus gallus
ISGLGSRFSG

SEQ ID NO: 46 - protein, 9 aa, Gallus gallus
LALRQSVEA

SEQ ID NO: 47 - protein, 10 aa, Gallus gallus
PLLGPPLLGI

SEQ ID NO: 48 - protein, 10 aa, Gallus gallus
VVTLPGPILS

SEQ ID NO: 49 - protein, 8 aa, Gallus gallus
VTLEDLRR

SEQ ID NO: 50 - protein, 9 aa, Gallus gallus
PILSSFPQN

SEQ ID NO: 51 - protein, 9 aa, Gallus gallus
PILSSFPQD

SEQ ID NO: 52 - protein, 11 aa, Gallus gallus
GTVGVSAGVTR

SEQ ID NO: 53 - protein, 9 aa, Gallus gallus
FGLSRVTLN

SEQ ID NO: 54 - protein, 12 aa, Gallus gallus
TAVGSSTSAAVG

SEQ ID NO: 55 - protein, 10 aa, Gallus gallus
VVVTLPGPIL

SEQ ID NO: 56 - protein, 10 aa, Gallus gallus
PPVVVTFPGP

SEQ ID NO: 57 - protein, 10 aa, Gallus gallus
PPPVVVTFPG

SEQ ID NO: 58 - protein, 10 aa, Gallus gallus
VVIQPSPVVV

SEQ ID NO: 59 - protein, 10 aa, Gallus gallus
FGISGLGSRF

SEQ ID NO: 60 - protein, 10 aa, Gallus gallus
PGPILSSFPQ

SEQ ID NO: 61 - protein, 10 aa, Gallus gallus
FGWSGLGRGL

SEQ ID NO: 62 - protein, 9 aa, Gallus gallus
LEAQLSELR

SEQ ID NO: 63 - protein, 9 aa, Gallus gallus
IVGAWYTVR

SEQ ID NO: 64 - protein, 11 aa, Gallus gallus
LLSPPGLPGLL

SEQ ID NO: 65 - protein, 11 aa, Gallus gallus
VVVTLPGPILS

SEQ ID NO: 66 - protein, 11 aa, Gallus gallus
GFGISGLGSRF

SEQ ID NO: 67 - protein, 11 aa, Gallus gallus
PVVVTLPGPIL

SEQ ID NO: 68 - protein, 11 aa, Gallus gallus
VSQGEITVPSI

SEQ ID NO: 69 - protein, 11 aa, Gallus gallus
SILSEEGVPIS

SEQ ID NO: 70 - protein, 11 aa, Gallus gallus
PVVVTFPGPIL

SEQ ID NO: 71 - protein, 13 aa, Gallus gallus
PISSGGFGISGLG

SEQ ID NO: 72 - protein, 13 aa, Gallus gallus
VGSSTSAAVGSIL

SEQ ID NO: 73 - protein, 11 aa, Gallus gallus
GFLSSAVSLNR

SEQ ID NO: 74 - protein, 12 aa, Gallus gallus
GGFGISGLGSRF

SEQ ID NO: 75 - protein, 11 aa, Gallus gallus
PGPILSSFPQN

SEQ ID NO: 76 - protein, 11 aa, Gallus gallus
PGPILSSFPQD

SEQ ID NO: 77 - protein, 12 aa, Gallus gallus
GGFGWSGLGRGL

SEQ ID NO: 78 - protein, 12 aa, Gallus gallus
PSPVVVTLPGPI

SEQ ID NO: 79 - protein, 12 aa, Gallus gallus
VVVTLPGPILSS

SEQ ID NO: 80 - protein, 12 aa, Gallus gallus
PVVVTLPGPILS

SEQ ID NO: 81 - protein, 12 aa, Gallus gallus
SPVVVTLPGPIL

SEQ ID NO: 82 - protein, 11 aa, Gallus gallus
RVVIQPSPVVV

SEQ ID NO: 83 - protein, 11 aa, Gallus gallus
QALTEVYAKAN

SEQ ID NO: 84 - protein, 10 aa, Gallus gallus
IETLTQFLGW

SEQ ID NO: 85 - protein, 13 aa, Gallus gallus
GFGSRSLVGLGGT

SEQ ID NO: 86 - protein, 14 aa, Gallus gallus
AVGSSTSAAVGSIL

SEQ ID NO: 87 - protein, 12 aa, Gallus gallus
PVVVTFPGPILS

SEQ ID NO: 88 - protein, 14 aa, Gallus gallus
VGSSTSAAVGSILS

SEQ ID NO: 89 - protein, 13 aa, Gallus gallus
GFGISGLGSRFSG

SEQ ID NO: 90 - protein, 13 aa, Gallus gallus
SGGFGISGLGSRF

SEQ ID NO: 91 - protein, 14 aa, Gallus gallus
VPISSGGFGISGLG

SEQ ID NO: 92 - protein, 12 aa, Gallus gallus
VVIQPSPVVVTL

SEQ ID NO: 93 - protein, 13 aa, Gallus gallus
SILSEEGVPISSG

SEQ ID NO: 94 - protein, 13 aa, Gallus gallus
VMGCKAAGASRII

SEQ ID NO: 95 - protein, 13 aa, Gallus gallus
SPVVVTLPGPILS

SEQ ID NO: 96 - protein, 12 aa, Gallus gallus
SRVVIQPSPVVV

SEQ ID NO: 97 - protein, 13 aa, Gallus gallus
PSPVVVTLPGPIL

SEQ ID NO: 98 - protein, 12 aa, Gallus gallus
RVVIQPSPVVVT

SEQ ID NO: 99 - protein, 13 aa, Gallus gallus
PPPVVVTLPGPIL

SEQ ID NO: 100 - protein, 15 aa, Gallus gallus
GVPISSGGFGISGLG

SEQ ID NO: 101 - protein, 13 aa, Gallus gallus
VIQPSPVVVTLPG

SEQ ID NO: 102 - protein, 15 aa, Gallus gallus
AVGSSTSAAVGSILS

SEQ ID NO: 103 - protein, 15 aa, Gallus gallus
TAVGSSTSAAVGSIL

SEQ ID NO: 104 - protein, 14 aa, Gallus gallus
SGGFGISGLGSRFS

SEQ ID NO: 105 - protein, 13 aa, Gallus gallus
VVVTLPGPILSSF

SEQ ID NO: 106 - protein, 13 aa, Gallus gallus
PPPVVVTFPGPIL

SEQ ID NO: 107 - protein, 14 aa, Gallus gallus
GLGGFGWSGLGRGL

SEQ ID NO: 108 - protein, 13 aa, Gallus gallus
VTLPGPILSSFPQ

SEQ ID NO: 109 - protein, 14 aa, Gallus gallus
AVGSILSEEGVPIS

SEQ ID NO: 110 - protein, 14 aa, Gallus gallus
SLGLGGFGWSGLGR

SEQ ID NO: 111 - protein, 14 aa, Gallus gallus
PSPVVVTLPGPILS

SEQ ID NO: 112 - protein, 13 aa, Gallus gallus
SRVVIQPSPVVVT

SEQ ID NO: 113 - protein, 15 aa, Gallus gallus
SGGFGISGLGSRFSG

SEQ ID NO: 114 - protein, 14 aa, Gallus gallus
PPPVVVTLPGPILS

SEQ ID NO: 115 - protein, 14 aa, Gallus gallus
VAIQPPPVVVTLPG

SEQ ID NO: 116 - protein, 15 aa, Gallus gallus
PISSGGFGISGLGSR

SEQ ID NO: 117 - protein, 13 aa, Gallus gallus
PIVDVAEALLHVK

SEQ ID NO: 118 - protein, 14 aa, Gallus gallus
VVIQPSPVVVTLPG

SEQ ID NO: 119 - protein, 13 aa, Gallus gallus
RVVIQPSPVVVTL

SEQ ID NO: 120 - protein, 16 aa, Gallus gallus
TAVGSSTSAAVGSILS

SEQ ID NO: 121 - protein, 14 aa, Gallus gallus
PPPVVVTFPGPILS

SEQ ID NO: 122 - protein, 15 aa, Gallus gallus
SLGLGGFGWSGLGRG

SEQ ID NO: 123 - protein, 14 aa, Gallus gallus
VVVTLPGPILSSFP

SEQ ID NO: 124 - protein, 14 aa, Gallus gallus
PVVVTLPGPILSSF

SEQ ID NO: 125 - protein, 15 aa, Gallus gallus
AAVGSILSEEGVPIS

SEQ ID NO: 126 - protein, 15 aa, Gallus gallus
SAAVGSILSEEGVPI

SEQ ID NO: 127 - protein, 16 aa, Gallus gallus
EGVPISSGGFGISGLG

SEQ ID NO: 128 - protein, 14 aa, Gallus gallus
VVTLPGPILSSFPQ

SEQ ID NO: 129 - protein, 15 aa, Gallus gallus
PSPVVVTLPGPILSS

SEQ ID NO: 130 - protein, 16 aa, Gallus gallus
GKDGPKGVRGDAGPPG

SEQ ID NO: 131 - protein, 15 aa, Gallus gallus
SVAIQPPPVVVTLPG

SEQ ID NO: 132 - protein, 14 aa, Gallus gallus
SRVVIQPSPVVVTL

SEQ ID NO: 133 - protein, 14 aa, Gallus gallus
LHTEAAATVPDRSE

SEQ ID NO: 134 - protein, 15 aa, Gallus gallus
VVIQPSPVVVTLPGP

SEQ ID NO: 135 - protein, 14 aa, Gallus gallus
RVVIQPSPVVVTLP

SEQ ID NO: 136 - protein, 16 aa, Gallus gallus
SAAVGSILSEEGVPIS

SEQ ID NO: 137 - protein, 15 aa, Gallus gallus
PVVVTLPGPILSSFP

SEQ ID NO: 138 - protein, 15 aa, Gallus gallus
IQPSPVVVTLPGPIL

SEQ ID NO: 139 - protein, 17 aa, Gallus gallus
SVPIGAGGSLGLGGFGW

SEQ ID NO: 140 - protein, 16 aa, Gallus gallus
SLGLGGFGWSGLGRGL

SEQ ID NO: 141 - protein, 17 aa, Gallus gallus
FGGGFGGGDGILPAGEK

SEQ ID NO: 142 - protein, 17 aa, Gallus gallus
TAVGSSTSAAVGSILSE

SEQ ID NO: 143 - protein, 16 aa, Gallus gallus
PISSGGFGISGLGSRF

SEQ ID NO: 144 - protein, 19 aa, Gallus gallus
SAAVGSSLSAGSVPIGAGG

SEQ ID NO: 145 - protein, 17 aa, Gallus gallus
GVPISSGGFGISGLGSR

SEQ ID NO: 146 - protein, 15 aa, Gallus gallus
VVVTLPGPILSSFPQ

SEQ ID NO: 147 - protein, 15 aa, Gallus gallus
RVVIQPSPVVVTLPG

SEQ ID NO: 148 - protein, 15 aa, Gallus gallus
SRVVIQPSPVVVTLP

SEQ ID NO: 149 - protein, 16 aa, Gallus gallus
PSPVVVTLPGPILSSF

SEQ ID NO: 150 - protein, 16 aa, Gallus gallus
AIQPPPVVVTLPGPIL

SEQ ID NO: 151 - protein, 16 aa, Gallus gallus
IQPSPVVVTLPGPILS

SEQ ID NO: 152 - protein, 16 aa, Gallus gallus
VIQPSPVVVTLPGPIL

SEQ ID NO: 153 - protein, 17 aa, Gallus gallus
VPISSGGFGISGLGSRF

SEQ ID NO: 154 - protein, 16 aa, Gallus gallus
SRVVIQPSPVVVTLPG

SEQ ID NO: 155 - protein, 17 aa, Gallus gallus
SILSEEGVPISSGGFGI

SEQ ID NO: 156 - protein, 16 aa, Gallus gallus
PVVVTLPGPILSSFPQ

SEQ ID NO: 157 - protein, 16 aa, Gallus gallus
RVVIQPSPVVVTLPGP

SEQ ID NO: 158 - protein, 18 aa, Gallus gallus
SAAVGSILSEEGVPISSG

SEQ ID NO: 159 - protein, 16 aa, Gallus gallus
VVVTLPGPILSSFPQN

SEQ ID NO: 160 - protein, 18 aa, Gallus gallus
GVPISSGGFGISGLGSRF

SEQ ID NO: 161 - protein, 17 aa, Gallus gallus
PSPVVVTLPGPILSSFP

SEQ ID NO: 162 - protein, 17 aa, Gallus gallus
VAIQPPPVVVTLPGPIL

SEQ ID NO: 163 - protein, 17 aa, Gallus gallus
VIQPSPVVVTLPGPILS

SEQ ID NO: 164 - protein, 17 aa, Gallus gallus
VVIQPSPVVVTLPGPIL

SEQ ID NO: 165 - protein, 17 aa, Gallus gallus
SPVVVTLPGPILSSFPQ

SEQ ID NO: 166 - protein, 15 aa, Gallus gallus
VILSNTKTQYSIKIH

SEQ ID NO: 167 - protein, 17 aa, Gallus gallus
SRVVIQPSPVVVTLPGP

SEQ ID NO: 168 - protein, 17 aa, Gallus gallus
DSRVVIQPSPVVVTLPG

SEQ ID NO: 169 - protein, 17 aa, Gallus gallus
PVVVTLPGPILSSFPQN

SEQ ID NO: 170 - protein, 17 aa, Gallus gallus
RVVIQPSPVVVTLPGPI

SEQ ID NO: 171 - protein, 19 aa, Gallus gallus
GVPISSGGFGISGLGSRFS

SEQ ID NO: 172 - protein, 18 aa, Gallus gallus
SVAIQPPPVVVTLPGPIL

SEQ ID NO: 173 - protein, 18 aa, Gallus gallus
VAIQPPPVVVTLPGPILS

SEQ ID NO: 174 - protein, 18 aa, Gallus gallus
VVIQPSPVVVTLPGPILS

SEQ ID NO: 175 - protein, 18 aa, Gallus gallus
PSPVVVTLPGPILSSFPQ

SEQ ID NO: 176 - protein, 20 aa, Gallus gallus
GVPISSGGFGISGLGSRFSG

SEQ ID NO: 177 - protein, 18 aa, Gallus gallus
AVPLVRPVTMVPSIPGIP

SEQ ID NO: 178 - protein, 18 aa, Gallus gallus
PPPVVVTLPGPILSSFPQ

SEQ ID NO: 179 - protein, 18 aa, Gallus gallus
SPVVVTLPGPILSSFPQN

SEQ ID NO: 180 - protein, 18 aa, Gallus gallus
LPGPGLQLLHGTTTLAFK

SEQ ID NO: 181 - protein, 18 aa, Gallus gallus
PPPVVVTFPGPILSSFPQ

SEQ ID NO: 182 - protein, 19 aa, Gallus gallus
SVAIQPPPVVVTLPGPILS

SEQ ID NO: 183 - protein, 19 aa, Gallus gallus
SSVAIQPPPVVVTLPGPIL

SEQ ID NO: 184 - protein, 18 aa, Gallus gallus
RVVIQPSPVVVTLPGPIL

SEQ ID NO: 185 - protein, 19 aa, Gallus gallus
PSPVVVTLPGPILSSFPQN

SEQ ID NO: 186 - protein, 21 aa, Gallus gallus
SILSEEGVPISSGGFGISGLG

SEQ ID NO: 187 - protein, 19 aa, Gallus gallus
SRVVIQPSPVVVTLPGPIL

SEQ ID NO: 188 - protein, 19 aa, Gallus gallus
RVVIQPSPVVVTLPGPILS

SEQ ID NO: 189 - protein, 22 aa, Gallus gallus
SVPIGAGGSLGLGGFGWSGLGR

SEQ ID NO: 190 - protein, 22 aa, Gallus gallus
TAVGSSTSAAVGSILSEEGVPI

SEQ ID NO: 191 - protein, 22 aa, Gallus gallus
SAAVGSILSEEGVPISSGGFGI

SEQ ID NO: 192 - protein, 21 aa, Gallus gallus
SEEGVPISSGGFGISGLGSRF

SEQ ID NO: 193 - protein, 20 aa, Gallus gallus
SRVVIQPSPVVVTLPGPILS

SEQ ID NO: 194 - protein, 23 aa, Gallus gallus
SVPIGAGGSLGLGGFGWSGLGRG

SEQ ID NO: 195 - protein, 20 aa, Gallus gallus
DSRVVIQPSPVVVTLPGPIL

SEQ ID NO: 196 - protein, 23 aa, Gallus gallus
TAVGSSTSAAVGSILSEEGVPIS

SEQ ID NO: 197 - protein, 22 aa, Gallus gallus
LRGDVGPVGRTGEQGIAGPPGF

SEQ ID NO: 198 - protein, 21 aa, Gallus gallus
SRVVIQPSPVVVTLPGPILSS

SEQ ID NO: 199 - protein, 21 aa, Gallus gallus
VVIQPSPVVVTLPGPILSSFP

SEQ ID NO: 200 - protein, 22 aa, Gallus gallus
GVPISSGGFGISGLGSRFSGRR

SEQ ID NO: 201 - protein, 24 aa, Gallus gallus
SVPIGAGGSLGLGGFGWSGLGRGL

SEQ ID NO: 202 - protein, 21 aa, Gallus gallus
DSRVVIQPSPVVVTLPGPILS

SEQ ID NO: 203 - protein, 21 aa, Gallus gallus
VIQPSPVVVTLPGPILSSFPQ

SEQ ID NO: 204 - protein, 24 aa, Gallus gallus
AVGSILSEEGVPISSGGFGISGLG

SEQ ID NO: 205 - protein, 21 aa, Gallus gallus
RVVIQPSPVVVTLPGPILSSF

SEQ ID NO: 206 - protein, 23 aa, Gallus gallus
SILSEEGVPISSGGFGISGLGSR

SEQ ID NO: 207 - protein, 21 aa, Gallus gallus
IPSSVPESSFKIKGNSSSFHI

SEQ ID NO: 208 - protein, 22 aa, Gallus gallus
VAIQPPPVVVTLPGPILSSFPQ

SEQ ID NO: 209 - protein, 25 aa, Gallus gallus
TAVGSSTSAAVGSILSEEGVPISSG

SEQ ID NO: 210 - protein, 22 aa, Gallus gallus
VVIQPSPVVVTLPGPILSSFPQ

SEQ ID NO: 211 - protein, 23 aa, Gallus gallus
PSPVVVTLPGPILSSFPQNTAVG

SEQ ID NO: 212 - protein, 20 aa, Gallus gallus
KENFEVLCKDGTRKPVTDAE

SEQ ID NO: 213 - protein, 21 aa, Gallus gallus
SIQACKLAQSHGWGVMVSHRS

SEQ ID NO: 214 - protein, 22 aa, Gallus gallus
SRVVIQPSPVVVTLPGPILSSF

SEQ ID NO: 215 - protein, 22 aa, Gallus gallus
RVVIQPSPVVVTLPGPILSSFP

SEQ ID NO: 216 - protein, 23 aa, Gallus gallus
EQPPLCVASVSVKEPASETPAVP

SEQ ID NO: 217 - protein, 23 aa, Gallus gallus
SVAIQPPPVVVTLPGPILSSFPQ

SEQ ID NO: 218 - protein, 26 aa, Gallus gallus
SAAVGSILSEEGVPISSGGFGISGLG

SEQ ID NO: 219 - protein, 24 aa, Gallus gallus
SILSEEGVPISSGGFGISGLGSRF

SEQ ID NO: 220 - protein, 24 aa, Gallus gallus
PSPVVVTLPGPILSSFPQNTAVGS

SEQ ID NO: 221 - protein, 23 aa, Gallus gallus
VVIQPSPVVVTLPGPILSSFPQN

SEQ ID NO: 222 - protein, 23 aa, Gallus gallus
SRVVIQPSPVVVTLPGPILSSFP

SEQ ID NO: 223 - protein, 24 aa, Gallus gallus
SSVAIQPPPVVVTLPGPILSSFPQ

SEQ ID NO: 224 - protein, 23 aa, Gallus gallus
RVVIQPSPVVVTLPGPILSSFPQ

SEQ ID NO: 225 - protein, 25 aa, Gallus gallus
SILSEEGVPISSGGFGISGLGSRFS

SEQ ID NO: 226 - protein, 27 aa, Gallus gallus
TSAAVGSILSEEGVPISSGGFGISGLG

SEQ ID NO: 227 - protein, 26 aa, Gallus gallus
SILSEEGVPISSGGFGISGLGSRFSG

SEQ ID NO: 228 - protein, 24 aa, Gallus gallus
SRVVIQPSPVVVTLPGPILSSFPQ

SEQ ID NO: 229 - protein, 28 aa, Gallus gallus
TAVGSSTSAAVGSILSEEGVPISSGGFG

SEQ ID NO: 230 - protein, 28 aa, Gallus gallus
STSAAVGSILSEEGVPISSGGFGISGLG

SEQ ID NO: 231 - protein, 24 aa, Gallus gallus
RVVIQPSPVVVTLPGPILSSFPQN

SEQ ID NO: 232 - protein, 25 aa, Gallus gallus
SRVVIQPSPVVVTLPGPILSSFPQN

SEQ ID NO: 233 - protein, 25 aa, Gallus gallus
DSRVVIQPSPVVVTLPGPILSSFPQ

SEQ ID NO: 234 - protein, 29 aa, Gallus gallus
TAVGSSTSAAVGSILSEEGVPISSGGFGI

SEQ ID NO: 235 - protein, 29 aa, Gallus gallus
SAAVGSILSEEGVPISSGGFGISGLGSRF

SEQ ID NO: 236 - protein, 24 aa, Gallus gallus
VEQLVNLQHLDVAYNLLLEHAQLA

SEQ ID NO: 237 - protein, 28 aa, Gallus gallus
SVAIQPPPVVVTLPGPILSSFPQSTAVG

SEQ ID NO: 238 - protein, 28 aa, Gallus gallus
SILSEEGVPISSGGFGISGLGSRFSGRR

SEQ ID NO: 239 - protein, 30 aa, Gallus gallus
TSAAVGSILSEEGVPISSGGFGISGLGSRF

SEQ ID NO: 240 - protein, 29 aa, Gallus gallus
SSVAIQPPPVVVTLPGPILSSFPQSTAVG

SEQ ID NO: 241 - protein, 31 aa, Gallus gallus
STSAAVGSILSEEGVPISSGGFGISGLGSRF

SEQ ID NO: 242 - protein, 31 aa, Gallus gallus
PSPVVVTLPGPILSSFPQNTAVGSSTSAAVG

SEQ ID NO: 243 - protein, 33 aa, Gallus gallus
TAVGSSTSAAVGSILSEEGVPISSGGFGISGLG

SEQ ID NO: 244 - protein, 31 aa, Gallus gallus
AVGSILSEEGVPISSGGFGISGLGSRFSGRR

SEQ ID NO: 245 - protein, 27 aa, Gallus gallus
NKVLVHCAMGRSRSATLVLAYLMIYKN

SEQ ID NO: 246 - protein, 32 aa, Gallus gallus
SSVAIQPPPVVVTLPGPILSSFPQSTAVGSTA

SEQ ID NO: 247 - protein, 32 aa, Gallus gallus
AAVGSILSEEGVPISSGGFGISGLGSRFSGRR

SEQ ID NO: 248 - protein, 35 aa, Gallus gallus
TAVGSSTSAAVGSILSEEGVPISSGGFGISGLGSR

SEQ ID NO: 249 - protein, 33 aa, Gallus gallus
SAAVGSILSEEGVPISSGGFGISGLGSRFSGRR

SEQ ID NO: 250 - protein, 34 aa, Gallus gallus
PSPVVVTLPGPILSSFPQNTAVGSSTSAAVGSIL

SEQ ID NO: 251 - protein, 35 aa, Gallus gallus
PSPVVVTLPGPILSSFPQNTAVGSSTSAAVGSILS

SEQ ID NO: 252 - protein, 36 aa, Gallus gallus
TAVGSSTSAAVGSILSEEGVPISSGGFGISGLGSRF

SEQ ID NO: 253 - protein, 29 aa, Gallus gallus
RPRVYLHCTNPRHPKYREGDVTLFALNLS